(19) United States
(12) Patent Application Publication
(10) Pub. No.: US 2005/0223917 A1
(43) Pub. Date: Oct. 13, 2005

(54) Paste dispenser and method for controlling the same

(76) Inventors: Kyu Yong Bang, Gumi-si (KR); Yong Kyu Seo, Gimcheon-si (KR)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/869,692

(22) Filed: Jun. 16, 2004

(30) Foreign Application Priority Data
Apr. 13, 2004 (KR) P2004-25311

(51) Int. Cl. B41L 13/18

(52) U.S. Cl. 101/123; 101/126

(57) ABSTRACT

Paste dispenser and method for controlling the same, the paste dispenser for dispensing a desired paste pattern on a substrate including a stage for detachably placing the substrate thereon, a nozzle having a paste discharge opening opposite to a main surface of the substrate placed on the stage, for discharging the paste on the substrate while making relative movement to the stage, and section measuring means for measuring a section of a paste pattern on the substrate in a stationary state without relative movement to the substrate.

This application claims the benefit of the Korean Application No. P2004-0025311 filed on Apr. 13, 2004, which is hereby incorporated by reference.

### BACKGROUND OF THE INVENTION

1. Field of the Invention

The present invention relates to paste dispensers and a method for controlling the same, and more particularly, to a paste dispenser which enables simple and accurate measurement of a section of a paste pattern; and a method for controlling the same.

2. Background of the Related Art

In general, the paste dispenser dispenses various pastes, such as resistive paste, and sealing paste, on a substrate in a predetermined form, i.e., in a desired pattern.

The paste dispenser is provided with a stage for placing the substrate thereon, and head units each having a nozzle for dispensing the paste on the substrate. The head unit has a paste holding tube, and a nozzle in communication with the paste holding tube for discharging the paste onto the substrate. That is, the paste dispenser forms a desired paste pattern on the substrate by varying a relative position of the substrate and the nozzle. For verifying formation of a desired pattern, a section of the paste pattern is measured. The section measurement includes measurement of a form, an area, a height, and a width of the section of the paste pattern.

In the meantime, a related art for measuring the section of the paste pattern, for an example, a sectional form, or a sectional area, is disclosed in Korean Laid Open Patent No. 1995-031516. According to the Laid Open Patent No. 1995-031516, a surface height of the paste pattern is measured with an optical range finder from a measurement starting position. After storing a result of the measurement in a RAM (Random Access Memory) of a microcomputer, the substrate is moved to the next measuring point in pitches. The sectional form is calculated from a data obtained by repeating this process for n+1 times. Then, by multiplying the surface height and a pitch distance, the data, and adding together, the sectional area of the paste pattern is obtained. According to this, for measuring the section of the paste pattern, the substrate and the optical range finder are required to make relative movement for n+1 times.

However, the related art has the following problems.

First, in the related art, in measuring a particular section of the paste pattern, the sectional area is not measured directly. That is, by measuring heights of the paste pattern, and the area is calculated from the heights. Consequently, because the relative movement between the substrate and the range finder is required surely for obtaining the sectional form or the sectional area in the related art, the range finder or the substrate is moved. In this instance, an improper measurement environment, such as vibration, is caused, to drop reliability of the measured distance. Moreover, the requirement for performing another operation with an operator for obtaining the sectional area of the paste pattern takes a time which is unnecessary otherwise, to drop productivity.

Second, it is liable that a result of the sectional area measurement of the paste pattern calculated from the pitch distances in a measuring section is not proper, to affect a quality control.

### SUMMARY OF THE INVENTION

Accordingly, the present invention is directed to a paste dispenser and a method for controlling the same that substantially obviates one or more of the problems due to limitations and disadvantages of the related art.

An object of the present invention is to provide a paste dispenser and a method for controlling the same, which can provide a reliable measurement result of a paste pattern section, and shorten a process time to improve productivity by eliminating an unnecessary process.

Other object of the present invention is to provide a paste dispenser and a method for controlling the same, which enables accurate section measurement, for better quality control and improvement of the quality.

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these objects and other advantages and in accordance with the purpose of the present invention, as embodied and broadly described herein, the paste dispenser includes a stage for detachably placing the substrate thereon, a nozzle having a paste discharge opening opposite to a main surface of the substrate placed on the stage, for discharging the paste on the substrate while making relative movement to the stage, and section measuring means for measuring a section of a paste pattern on the substrate in a stationary state without relative movement to the substrate.

In the meantime, the section measuring means is preferably of a moving spot type or a line beam type. The moving spot type of section measuring device is stationary in the measurement. The moving spot type section measuring device measures the section by moving lenses inside of the measuring device in up/down directions to move a position of a laser spot in up/down, and left/right directions within the measuring device. A likely, the line beams type is also stationary in the measurement. As a laser beam from a light emitting part passes two upper/lower transmission lenses, to form one plane, and arrives to a measuring object, a desired section can be measured.

In other aspect of the present invention, there is provided a method for controlling a paste dispenser for dispensing a desired paste pattern on a substrate, including the steps of setting a section managing point to the paste pattern, making relative movement so that the set section managing point is positioned at section measuring means, and directly measuring a section without relative movement to the substrate.

It is to be understood that both the foregoing description and the following detailed description of the present invention are exemplary and explanatory and are intended to provide further explanation of the invention claimed.

### BRIEF DESCRITPION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings;

FIG. 1 illustrates a perspective view of a paste dispenser in accordance with a preferred embodiment of the present invention, schematically;

FIG. 2 illustrates a block diagram of a control system of a paste dispenser in accordance with a preferred embodiment of the present invention, schematically;

FIG. 3 illustrates a diagram of section measuring means in accordance with one preferred embodiment of the present invention, schematically;

FIG. 4 illustrates a diagram showing an operation state of the section measuring means in FIG. 3;

FIG. 5 illustrates a diagram of section measuring means in accordance with another preferred embodiment of the present invention, schematically; and

FIG. 6 illustrates a flow chart showing the steps of a method for measuring a section of a paste pattern in accordance with a preferred embodiment of the present invention.

### DETAILED DESCRIPTION OF THE PREFERRED EMBODIMENT

Reference will now be made in detail to the preferred embodiments of the present invention, examples of which are illustrated in the accompanying drawings. In describing the embodiments, identical parts will be given the same names and reference symbols, and repetitive description of which will be omitted.

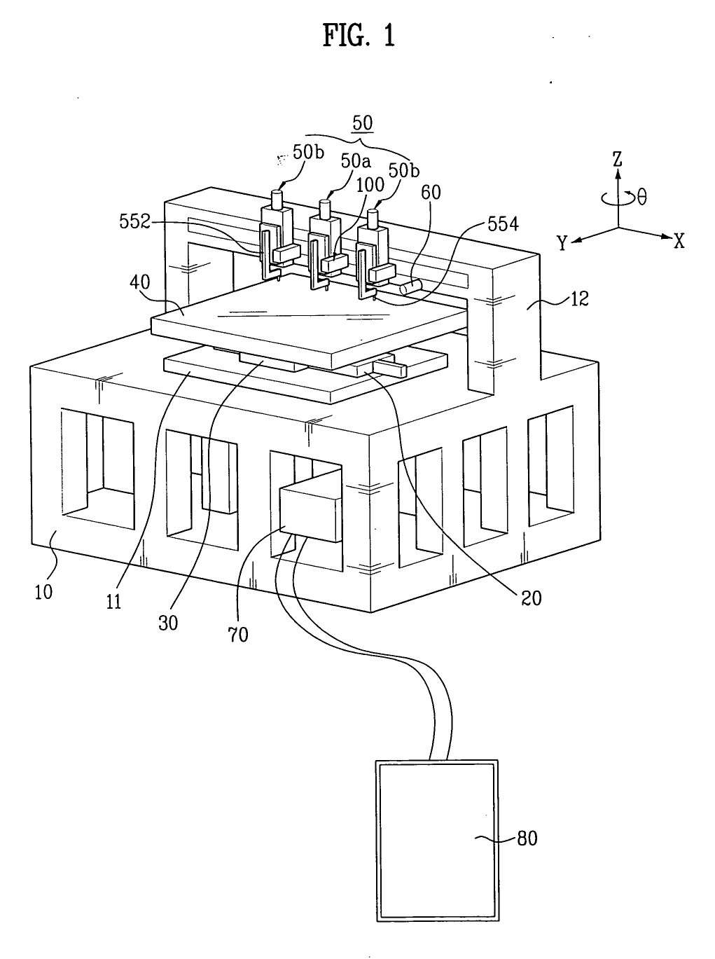

FIG. 1 illustrates a perspective view of a paste dispenser in accordance with a preferred embodiment of the present invention schematically.

Referring to FIG. 1, the paste dispenser includes an X-axis table 20 movably mounted on a frame 10 to be movable in an X-axis direction, a Y-axis table 30 movably mounted on the X-axis table 20 to be movable in a Y-axis direction, a θ-axis table (not shown) movably mounted on the Y-axis table 30 to be movable in a θ-axis direction, and a stage 40 on the θ-axis table for adsorbing the substrate. There is a column substantially at a middle of the frame 10 having a plurality of head units 50 each having a nozzle movable in a Z-axis direction and discharging paste, and a align camera 60 for aligning the substrate held at the stage 40.

In the meantime, the heat unit 50 has a paste holding tube 552 with the paste held therein, the nozzle 554, and X-, Y-, and Z-axis motors (not shown) for moving the nozzle 554 in X-, Y-, and Z-axis directions respectively.

The head unit 50a has a section measuring means 100 fitted thereto. The section measuring means 100 measures a sectional form, a sectional area, a sectional height, and a line width of the paste pattern directly, i.e., without movement of the section measuring means (will be described later). FIG. 1 illustrates the section measuring means 100 fitted to the heat unit 50a. However, a position of the section measuring means is not limited to the case of FIG. 1. Because there is no relative movement between the section measuring means and the substrate in measuring a particular section of the paste pattern. In other words, it is required to move the head unit 50 or the stage 40 to a measuring position only when the user moves the section measuring means to a position of the paste pattern intended to measure. Accordingly, the section measuring means 100 mounted on a movable stage 40 or on the column, fixedly. Moreover, the section measuring means may be mounted on a particular head unit or on all head units.

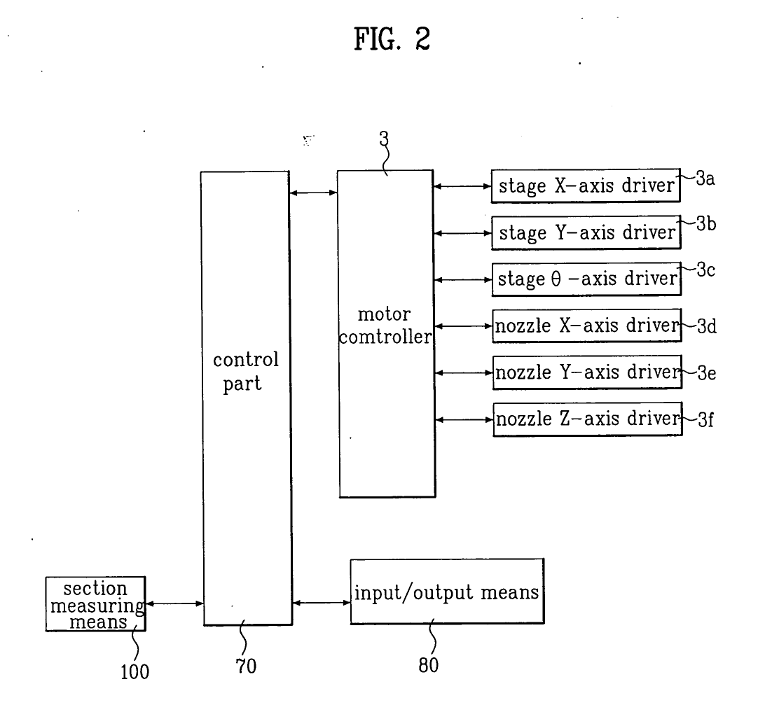

FIG. 2 illustrates a block diagram of a control system of a paste dispenser in accordance with a preferred embodiment of the present invention schematically, referring to which the control system of the paste dispenser will be described.

There is a control part 70, acting as a central processing unit, having a motor controller 3, the section measuring means 100, and an input/output (I/O) means 80 connected thereto. The motor controller 3 has a stage X-axis driver 3a, a stage Y-axis driver 3b, and a stage θ-axis driver 3c connected thereto. The motor controller 3 also has a nozzle X-axis driver 3d, a nozzle Y-axis driver 3e, and a nozzle Z-axis driver 3f connected thereto.

The stage X-, Y-, and θ-axis drivers 3a, 3b, and 3c control movement of the X-, Y-, and θ-axis tables, respectively. The nozzle X-, Y-, and Z-axis drivers 3d, 3e, and 3f make fine control a position of the nozzle 554 in X-, Y-, and Z-axis directions, respectively.

Thus, the paste dispenser forms a required form of the paste pattern as the substrate and the nozzle move relative to each other. Though FIG. 1 illustrates a case when the nozzle is fixed, and the substrate, i.e., the stage 40 moves in the X-, and Y-axis directions to form a required pattern, an opposite case, i.e., when the stage is fixed, and the nozzle is moved, is, of course, possible. After the required paste pattern is formed, the section of the paste pattern is measured for verifying if a paste pattern the user desires is formed. In measuring the section, the section measuring means 100 is connected to the control part 70, and measures the section according to a series of steps. The series of steps in the section measurement includes the step of setting a section managing point to the paste pattern, the step of making relative movement such that the section managing point is positioned at the section measuring means, and the step of measuring the section of the paste pattern with the section measuring means.

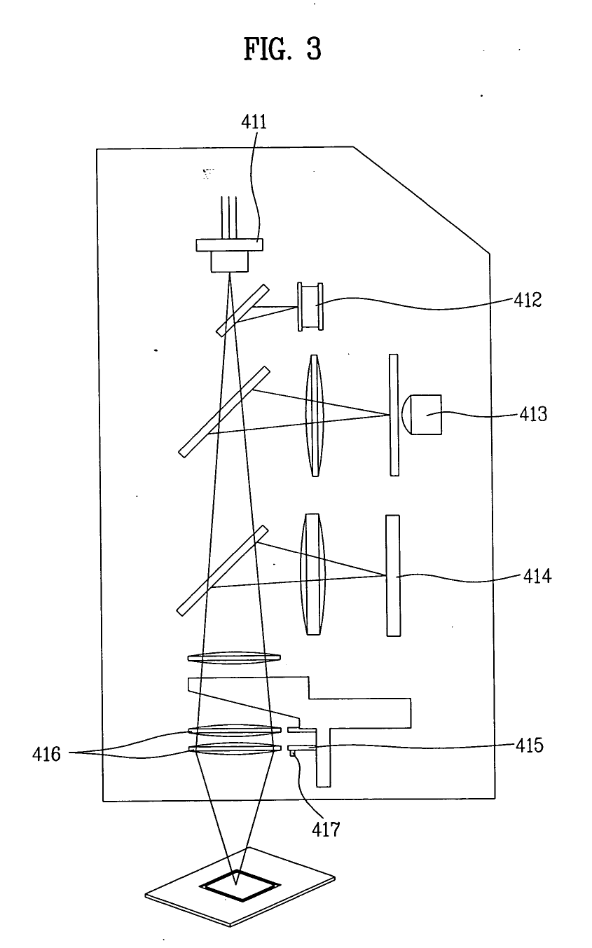

One embodiment of the section measuring means 100 will be described in detail with reference to FIG. 3. The section measuring means shown in FIG. 3 is a moving spot type section measuring device. In measuring the section, the measuring device is stationary, and a position of a laser spot is moved from an inside of the measuring device by moving lenses inside of the measuring device in up/down directions. A system of the moving spot type measuring device and a process for measuring the section will be described with reference to FIG. 3.

The moving spot type measuring device includes a light emitting part 411, a light receiving part 412, an illuminator 413, a CCD (Charge Coupled Device) camera 414, a vibrator 415, upper/lower lenses 416, and a sensor 417 for the vibrator. A laser beam from an LED in the light emitting part 411 passes through the upper/lower lenses 416 in the measuring device. After arrival to a surface of the paste pattern, the laser beam enters the light receiving part 412. In this instance, if the horse shoe form of vibrator 415 is vibrated, a distance between the upper/lower lenses 416 is changed. Then, a path of the laser beam is changed, and the light receiving part 412 determines a position where a quantity of received light is the maximum as the focal point of the lens. In this instance, a distance between the paste pattern and the section is measured by using the sensor 417 that senses vibration of the horse shoe form of vibrator 415. When the lenses 416 are moved in up/down directions, the focal point of the laser beam moves on the paste pattern in up/down, and left/right directions, scanning the section of the paste pattern. A data obtained by scanning the section of the paste pattern with the laser beam is displayed as an image by the illuminator 413 and the CCD camera 414.

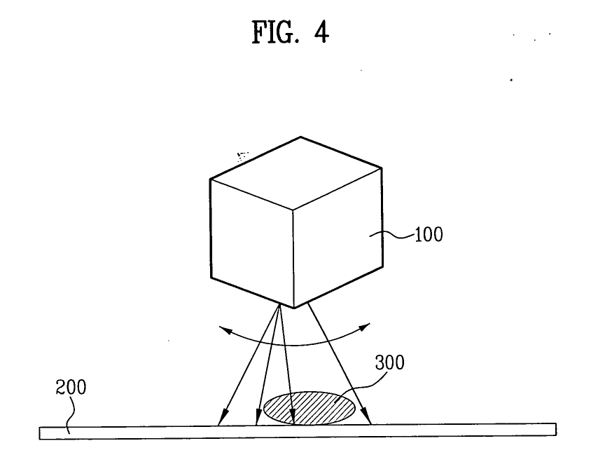

In the meantime, FIG. 4 illustrates a state in which the section of the paste pattern is measured by using the moving spot type measuring device. In measuring a particular section, the section measuring means 100 and the substrate 200 are stationary. As the lenses move in up/down directions (not shown) within the section measuring means 100, the focal point of the laser beam moves in up/down, and left/right directions, and measures the section of the paste pattern 300.

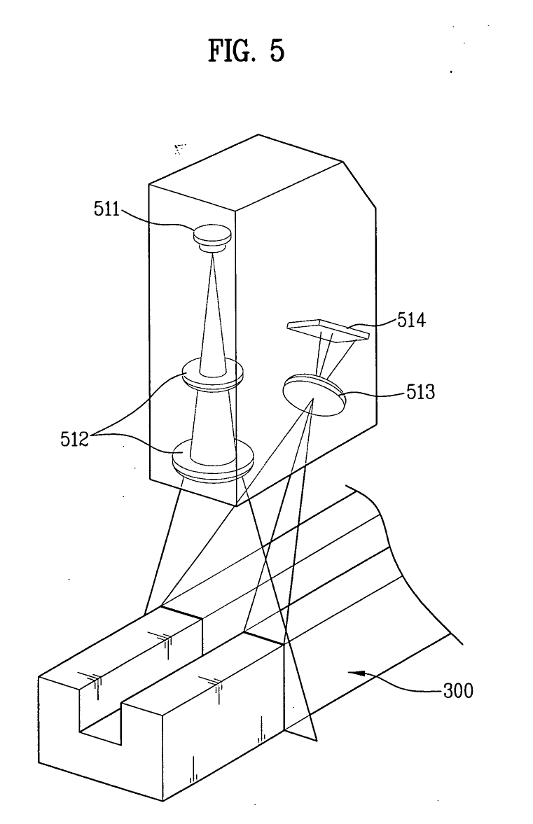

Another embodiment of the section measuring means will be described with reference to FIG. 5. The embodiment is on a line beam type section measuring device. A system of the measuring device and a process for measuring a section of the paste pattern will be described in succession.

The line beam type section measuring device includes a light emitting part 511, upper/lower light transmission lenses 512, a light receiving lens 513, and a CCD 514. A laser beam from an LED in the light emitting part 511 passes through the upper/lower light transmission lenses 512 in the measuring device. In this instance, the laser beam forms a line beam. After arrival to a surface of the paste pattern, the line beam passes through the light receiving lens 513. Then, the CCD 514 receives the laser beam passed through the light receiving lens, processes as a data, and displays the data in an image. Through this, the sectional area, the sectional form, the sectional height, and the line width can be obtained, directly.

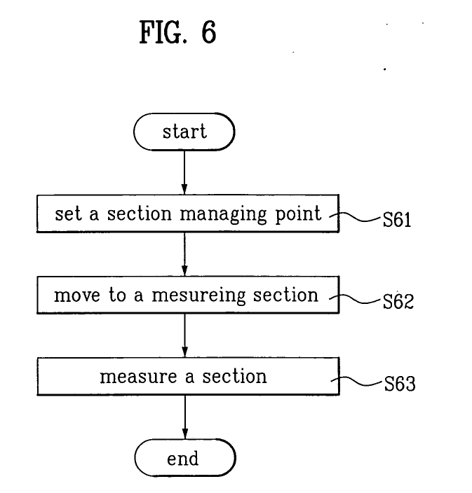

A method for measuring a section of the paste pattern will be described with reference to FIG. 6.

Even though measurement of sections of all of the paste patterns is possible, the step S61 of setting a section managing point to a paste pattern is a step of setting part particularly required to measure as a managing point. The paste pattern formed by the paste dispenser of the present invention is on a part of the substrate, from which the user selects a position of section intended to measure by using the input/output means connected to the control part of the paste dispenser.

After the step of setting a section managing point, a moving step S62 is performed in which a relative movement between the section measuring means and the substrate having the paste pattern formed thereon is made so that the managing point is positioned at the section measuring means. That is, the head unit 50a having the section measuring means 100 mounted thereon moves to the position of the section of the paste pattern intended to measure while making a relative movement to the stage 40 having the substrate placed thereon. Since the relative movement between the head unit 50a and the stage 40 is also required in dispensing the paste, detailed description of the relative movement will be omitted because the same can be applicable.

By performing the step S63 of measuring the section of the paste pattern by using the section measuring means, the method for measuring a section is finished. It is preferable that the section measuring means is the moving spot type measuring device or the line beam type measuring device. Description of the method for measuring a section by using the section measuring device will be omitted because same is described in description of the system of the section measuring device, and the embodiments (see FIG. 4).

It is preferable that the section measuring means measures the section directly without relative movement between the substrate and the section measuring means.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

The paste dispenser and method for controlling the same of the present invention have the following advantages.

First, the section measurement of in stationary positions of the substrate and the section measuring means without making relative movement to each other, eliminating improper measuring environment, permits to obtain accurate sectional form, sectional area, section height, and line width, and shorten a process time to improve a productivity as no unnecessary calculation is required for obtaining the sectional area of the paste pattern.

According to a comparative test data of the inventors, in measurement of a particular section of the paste pattern, there have been measured height and calculation errors in a range of 15% in the related art. Contrary to this, in the present invention, the measured height error is 0.5%, and there is no calculation error. Also in the section measuring time, though about 5 seconds are required in the related art, about 2 seconds are required in the present invention.

Second, the direct measurement of the section regardless of pitch intervals of the measuring section for measuring a particular section of a paste pattern permits to obtain an accurate measurement result, through which quality control and improvement can be achieved.

1. A paste dispenser for dispensing a desired paste pattern on a substrate comprising:
a stage for detachably placing the substrate thereon;
a nozzle having a paste discharge opening opposite to a main surface of the substrate placed on the stage, for discharging the paste on the substrate while making relative movement to the stage; and
section measuring means for measuring a section of a paste pattern on the substrate in a stationary state without relative movement to the substrate.

2. The paste dispenser as claimed in claim 1, wherein the section measuring means is of a moving spot type which can move a laser spot in up/down, and left/right directions.

3. The paste dispenser as claimed in claim 1, wherein the section measuring means is of a line beam type.

4. A method for controlling a paste dispenser for dispensing a desired paste pattern on a substrate, comprising the steps of:
setting a section managing point to the paste pattern;
making relative movement so that the set section managing point is positioned at section measuring means; and
directly measuring a section without relative movement to the substrate.
